(19) United States
(12) Patent Application Publication
(10) Pub. No.: US 2020/0096907 A1
(43) Pub. Date: Mar. 26, 2020

(54) Toner Supply Device, Developing Device, and Image Forming Apparatus

(71) Applicant: KONICA MINOLTA, INC., Tokyo (JP)

(72) Inventors: Hideji HIGASHIMURA, Toyokawa-shi (JP); Kie HAYASHI, Toyokawa-shi (JP)

(73) Assignee: KONICA MINOLTA, INC., Tokyo (JP)

(21) Appl. No.: 16/574,300

(22) Filed: Sep. 18, 2019

(30) Foreign Application Priority Data
Sep. 26, 2018 (JP) 2018-180578

(51) Int. Cl. G03G 15/08

(52) U.S. Cl. CPC G03G 15/0889; G03G 2215/0827; G03G 2215/0855; G03G 15/0891

(57) ABSTRACT

A toner supply device includes a toner storage unit that stores toner for supply, and a stirring unit that stirs the toner stored in the toner storage unit. The toner storage unit includes an inlet for introducing the toner from a toner container to the toner storage unit, and an intake portion that takes in the toner to a supply path for supplying the toner toward a developing device. The stirring unit includes a paddle portion provided to be rotatable about an axis of rotation for moving the toner toward the intake portion, and a screw portion for transporting the toner toward the paddle portion. The screw portion transports the toner in a direction of the axis of rotation of the paddle portion.

The entire disclosure of Japanese Patent Application No. 2018-180578, filed on Sep. 26, 2018, is incorporated herein by reference in its entirety.

### BACKGROUND

### Technological Field

The present disclosure relates to a toner supply device, a developing device, and an image forming apparatus.

### Description of the Related Art

A conventional toner supply device is disclosed in, for example, Japanese Laid-Open Patent Publication No. 2016-145923.

In the toner supply device disclosed in Japanese Laid-Open Patent Publication No. 2016-145923, an interlocking member, which operates in conjunction with a plate-shaped stirring paddle (stirring member), is provided below a toner supply port for supplying toner to a toner storage chamber. The plate-shaped stirring paddle presses and moves the interlocking member when rotating to stir the toner in the toner storage chamber. Consequently, the remaining toner can be moved below the toner supply port.

### SUMMARY

In the toner supply device disclosed in Japanese Laid-Open Patent Publication No. 2016-145923, however, the stirring paddle mainly moves toner perpendicularly to the axis of rotation of the stirring paddle, which limits a range in which the stirring paddle can transport the toner to considerable extent. In such a case, the toner may remain in a region which is unreachable by the stirring paddle and the interlocking member and is apart from an inlet (toner intake port) of a toner discharge path for discharging the toner from the toner storage chamber. If the toner remains, the toner may harden, making it difficult to stably supply the toner to the developing device.

The present disclosure has been made in view of the above problem, and an object of the present disclosure is to provide a toner supply device, a developing device, and an image forming apparatus that can flow toner stably.

To achieve at least one of the abovementioned objects, according to an aspect of the present invention, a toner supply device reflecting one aspect of the present invention comprises a toner storage unit that stores toner for supply, and a stirring unit that stirs the toner stored in the toner storage unit. The toner storage unit includes an inlet for introducing the toner from a toner container to the toner storage unit, and an intake portion that takes in the toner to a supply path for supplying the toner toward a developing device. The stirring unit includes a paddle portion provided to be rotatable about an axis of rotation for moving the toner toward the intake portion, and a screw portion for transporting the toner toward the paddle portion. The screw portion transports the toner in a direction of the axis of rotation of the paddle portion.

To achieve at least one of the abovementioned objects, according to an aspect of the present invention, an image forming apparatus reflecting one aspect of the present invention comprises the developing device, and a transfer unit that transfers the toner image developed by the developing device onto a recording medium.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic view of an image forming apparatus according to an embodiment.

FIG. 2 is a sectional view of a toner supply device according to the embodiment.

FIG. 3 is a sectional perspective view of the toner supply device according to the embodiment.

FIG. 4 partially shows a stirring unit of the toner supply device according to the embodiment.

FIG. 5 is a perspective view of a stirring member according to the embodiment.

FIG. 6 is a perspective view showing configurations of the stirring member and its vicinity according to the embodiment.

FIG. 7 is a sectional perspective view showing how a screw portion and a stirring paddle stir toner in the toner supply device according to the embodiment.

FIG. 8 is a sectional view showing how the stirring member stirs toner in the toner supply device according to the embodiment.

### DETAILED DESCRIPTION OF EMBODIMENTS

Hereinafter, one or more embodiments of the present invention will be described with reference to the drawings. However, the scope of the invention is not limited to the disclosed embodiments.

The same or corresponding components are designated by the same reference characters in an embodiment described below, and description thereof may not be repeated.

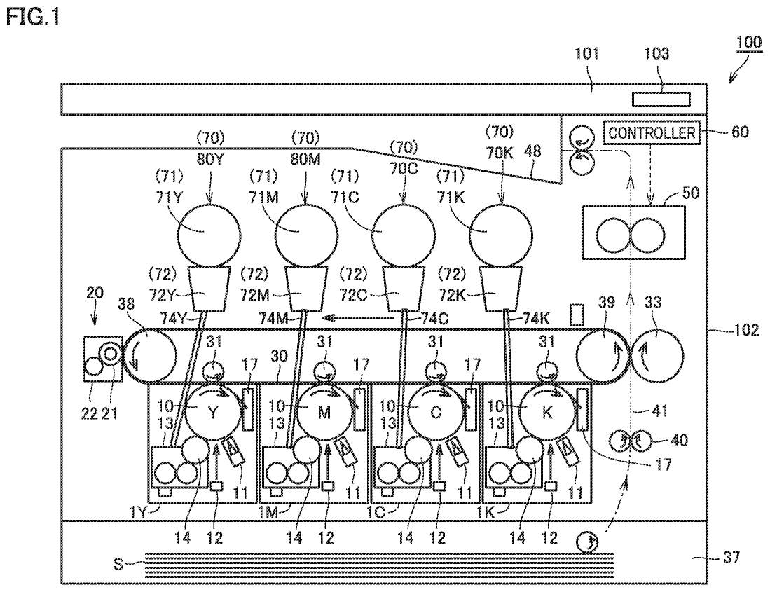

FIG. 1 is a schematic view of an image forming apparatus according to an embodiment. An image forming apparatus 100 according to the embodiment will be described with reference to FIG. 1.

As shown in FIG. 1, image forming apparatus 100 mainly includes an image reading unit 101 that reads an image of a document and a printing unit 102 that prints an image.

Image reading unit 101 includes an operation panel 103. Operation panel 103 has various input key groups including ten keys, a touch sensor, and the like as the functions of an input unit and various indicators including, for example, a liquid crystal display integrated with the touch sensor and light emitting diodes (LEDs) as the functions of the display unit.

Printing unit 102 includes image forming units 1Y, 1M, 1C, and 1K, an intermediate transfer belt 30, primary transfer rollers 31, a secondary transfer roller 33, a cassette 37, a driven roller 38, a driving roller 39, a timing roller 40, a fixing device 50, a controller 60, toner supply devices 70Y, 70M, 70C, and 70K (merely referred to as toner supply device 70 when they are not differentiated from each other), and a cleaning device 20.

Image forming units 1Y, 1M, 1C, and 1K are arranged in order along intermediate transfer belt 30. Image forming units 1Y, 1M, 1C, and 1K are supplied with toner from toner supply devices 70Y, 70M, 70C, and 70K, respectively, thereby forming toner images.

Image forming unit 1Y is supplied with toner from toner supply device 70Y to form a yellow (Y) toner image. Image forming unit 1M is supplied with toner from toner supply device 70M to form a magenta (M) toner image. Image forming unit 1C is supplied with toner from toner supply device 70C to form a cyan (C) toner image. Image forming unit 1K is supplied with toner from toner supply device 70K to form a black (BK) toner image.

Toner supply devices 70Y, 70M, 70C, and 70K respectively include toner bottles (toner containers) 71Y, 71M, 71C, and 71K and toner storage units 72Y, 72M, 72C, and 72K. Toner bottles 71Y, 71M, 71C, and 71K are referred to as toner bottle 71 when they are not differentiated from each other, and toner storage units 72Y, 72M, 72C, and 72K are referred to as toner storage unit 72 when they are not differentiated from each other.

Toner bottles 71Y, 71M, 71C, and 71K are detachably attached to toner storage units 72Y, 72M, 72C, and 72K, respectively. Toner storage units 72Y, 72M, 72C, and 72K temporarily store toner supplied from toner bottles 71Y, 71M, 71C, and 71K, respectively. When the residual amount of the toner in toner storage units 72Y, 72M, 72C, and 72K decreases, toner is supplied from toner bottles 71Y, 71M, 71C, and 71K.

Toner storage units 72Y, 72M, 72C, and 72K supply toner to developing devices 13 of image forming units 1Y, 1M, 1C, and 1K through supply paths 74Y, 74M, 74C, and 74K, respectively. Supply paths 74Y, 74M, 74C, and 74K are referred to as supply path 74 when they are not differentiated from each other.

Image forming units 1Y, 1M, 1C, and 1K are arranged in order in the direction of rotation of intermediate transfer belt 30 along intermediate transfer belt 30. Image forming units 1Y, 1M, 1C, and 1K each include a photoconductor 10 serving as an image carrier, a charging device 11, an exposing device 12, a developing device 13, and a cleaning device 17.

Charging device 11 charges the surface of photoconductor 10 uniformly. Exposing device 12 irradiates photoconductor 10 with laser light in response to a control signal from controller 60, thereby exposing the surface of photoconductor 10 to light in accordance with an input image pattern. An electrostatic latent image corresponding to the input image is thus formed on photoconductor 10.

Developing device 13 applies a developing bias to developing roller 14 while rotating developing roller 14, thus causing the toner to adhere to the surface of developing roller 14. Consequently, the toner is transferred from developing roller 14 to photoconductor 10, so that a toner image corresponding to the electrostatic latent image is developed on the surface of photoconductor 10. Developing device 13 develops the electrostatic latent image formed on photoconductor 10 to form a toner image on the photoconductor.

Photoconductor 10 and intermediate transfer belt 30 are in contact with each other at a portion at which primary transfer roller 31 is provided. Primary transfer roller 31 has a roller shape and is configured to be rotatable. A transfer voltage of the polarity opposite to that of the toner image is applied to primary transfer roller 31, causing the toner image to be transferred from photoconductor 10 to intermediate transfer belt 30.

The yellow (Y) toner image, the magenta (M) toner image, the cyan (C) toner image, and the black (BK) toner image are overlaid in order to be transferred from photoconductor 10 onto intermediate transfer belt 30. Consequently, a color toner image is formed on intermediate transfer belt 30.

Intermediate transfer belt 30 is laid across driven roller 38 and driving roller 39. Driving roller 39 is drivingly rotated by, for example, a motor (not shown). Intermediate transfer belt 30 and driven roller 38 rotate in conjunction with driving roller 39. Consequently, the toner image on intermediate transfer belt 30 is transported to secondary transfer roller 33.

Cleaning device 17 is pressed against photoconductor 10. Cleaning device 17 collects the toner remaining on the surface of photoconductor 10 after the transfer of the toner image.

Sheets S, which are recording media, are placed in cassette 37. Sheets S are transported one by one from cassette 37 along transport path 41 to secondary transfer roller 33 by timing roller 40.

Secondary transfer roller 33 has a roller shape and is configured to be rotatable. Secondary transfer roller 33 applies a transfer voltage of the polarity opposite to that of the toner image to sheet S being transported. This causes the toner image to be attracted from intermediate transfer belt 30 to secondary transfer roller 33, so that the toner image on intermediate transfer belt 30 is transferred. Primary transfer rollers 31, intermediate transfer belt 30, and secondary transfer roller 33 correspond to a transfer unit that transfers the toner image developed by the developing device onto sheet S (recording medium).

The toner remaining on intermediate transfer belt 30 is removed by cleaning device 20. Cleaning device 20 has a transfer belt cleaner 21 and a waste toner box 22. The remaining toner is collected by transfer belt cleaner 21 and is stored in waste toner box 22.

A timing at which sheet S is transported to secondary transfer roller 33 is adjusted by timing roller 40 in accordance with the position of the toner image on intermediate transfer belt 30. Timing roller 40 allows the toner image on intermediate transfer belt 30 to be transferred to an appropriate position of sheet S.

Fixing device 50 pressurizes and heats sheet S passing therethrough. The toner image is accordingly fixed onto sheet S. Sheet S is then ejected to a tray 48.

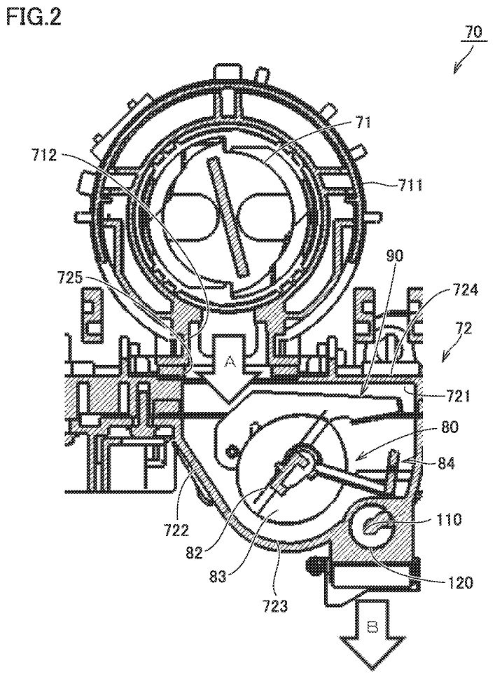

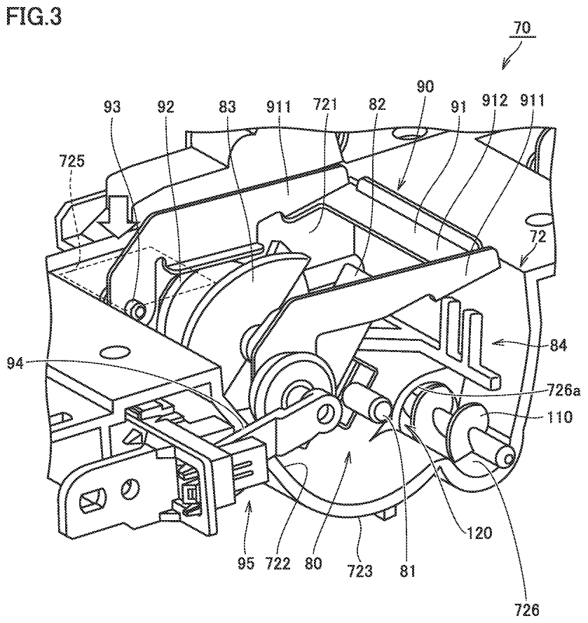

FIG. 2 is a sectional view of a toner supply device according to the embodiment. FIG. 3 is a sectional perspective view of the toner supply device according to the embodiment. FIG. 3 omits the configuration in the vicinity of the toner bottle. Toner supply device 70 will be described with reference to FIGS. 2 and 3.

Toner storage unit 72 has a pair of planar lateral surfaces 721 opposed to each other, a bottom portion 723, and a lid portion 724 covering an upper portion of toner storage unit 72. Bottom portion 723 couples the opposed lateral surfaces, and part of bottom portion 723 forms a guiding wall portion 722, which will be described below. Toner storage unit 72 is also provided with an inlet 725 and a toner intake portion 726. Inlet 725 serves to introduce toner from toner bottle 71 to toner storage unit 72. Toner intake portion 726 is a portion for taking in toner to a supply path 120 for supplying toner toward developing device 13.

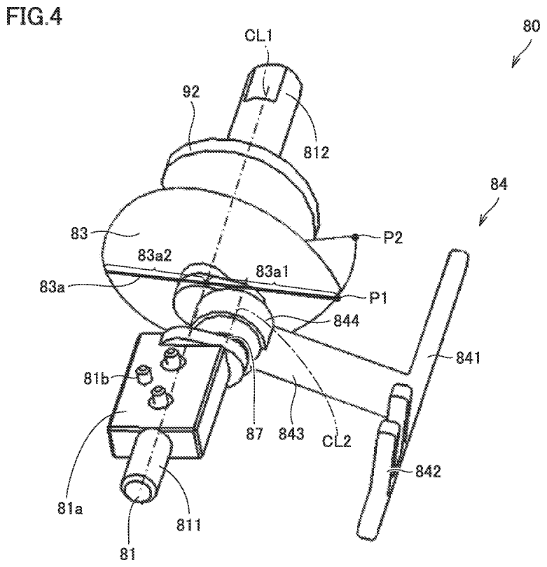

Toner intake portion 726 is located at least apart from inlet 725 in a direction of an axis of rotation CL1 (see FIG. 4) of a rotational shaft 81, which will be described below. Inlet 725 and toner intake portion 726 are located so as not to overlap each other. This arrangement of inlet 725 and toner intake portion 726 can increase an amount by which toner is stored in toner storage unit 72. For example, inlet 725 and toner intake portion 726 are diagonally opposite in toner storage unit 72 as viewed from above (in plan view).

The pair of lateral surfaces 721 are arranged side by side in the direction of axis of rotation CL1 (see FIG. 4) of rotational shaft 81. The pair of lateral surfaces 721 are arranged parallel to each other, and each of the pair of lateral surfaces 721 and bottom portion 723 are provided to be orthogonal to each other. The configuration of toner storage unit 72 is not limited to this configuration and may be various configurations in which supplied toner can be stored.

Lid portion 724 is provided to cover an opening of toner storage unit 72 which is open upward. Lid portion 724 is connected to a bottle holder 711 for attaching toner bottle 71. Lid portion 724 is provided with inlet 725. Inlet 725 is provided directly below a discharge port 712 of toner bottle 71. The toner discharged from discharge port 712 is introduced into toner storage unit 72 through inlet 725.

Guiding wall portion 722 is arranged directly below inlet 725. Guiding wall portion 722 inclines to be directed toward stirring unit 80 as extending downward. The toner supplied from inlet 725 is guided toward stirring unit 80 by guiding wall portion 722.

Toner intake portion 726 and transport member 110 are provided in the lower portion of toner storage unit 72. Transport member 110 is a member for transporting the toner stored in toner storage unit 72 toward developing device 13. Specifically, transport member 110 transports the toner into supply path 120 connected to toner intake portion 726 of toner storage unit 72. Transport member 110 comes in supply path 120 from toner intake portion 726 and extends along supply path 120. In plan view, transport member 110 is spaced from a stirring paddle 82, which will be described below.

A first end side of supply path 120 is connected to an intake port 726a provided in toner storage unit 72. Toner is taken in from intake port 726a to supply path 120. A second end side of supply path 120 is connected to supply path 74 described above. Supply path 120 is provided substantially horizontally. Supply path 120 extends in, for example, the direction of axis of rotation CL1.

Stirring unit 80 includes rotational shaft 81, stirring paddle 82, a screw portion 83, and a stirring member 84. Rotational shaft 81 is rotated by a drive unit (not shown). Stirring paddle 82 has a plate shape. Stirring paddle 82 and screw portion 83 are provided in rotational shaft 81. In other words, screw portion 83 is provided in rotational shaft 81 provided with stirring paddle 82. Stirring paddle 82 and screw portion 83 are provided to rotational shaft 81, which is a single member, as described above, leading to a simplified configuration.

Stirring paddle 82 and screw portion 83 are provided to be rotatable about the axis of rotation. The rotation of rotational shaft 81 causes stirring paddle 82 and screw portion 83 to rotate. Screw portion 83 transports the toner toward stirring paddle 82. Screw portion 83 transports the toner in the direction of the axis of rotation of stirring paddle 82. In the embodiment, the axis of rotation of stirring paddle 82 and the axis of rotation of screw portion 83 coincide with axis of rotation CL1 of rotational shaft 81.

Screw portion 83 is provided on the side close to inlet 725 with respect to stirring paddle 82. Stirring paddle 82 is provided on the side close to toner intake portion 726 with respect to screw portion 83. This arrangement of screw portion 83 and stirring paddle 82 allows screw portion 83 to efficiently transport the toner supplied from inlet 725 toward stirring paddle 82, which will be described below.

Another shaft (shaft portion) 87 (see FIG. 4) is connected to rotational shaft 81, as described below. Stirring member 84 is provided in shaft 87. Stirring member 84 is provided to be operable in conjunction with the rotation of stirring paddle 82. The rotation of rotational shaft 81 moves shaft 87, thereby moving stirring member 84. Stirring member 84 is provided so as to oscillate in the direction crossing the direction of the axis of rotation of screw portion 83.

Stirring member 84 is disposed above transport member 110. Stirring member 84 stirs a portion of the toner stored in toner storage unit 72, which is located above transport member 110. Also, stirring member 84 is disposed below the liquid surface of toner with which a toner residual amount detection member 91, which will be described below, comes into contact. Stirring member 84 accordingly stirs the toner located below the liquid surface of toner with which toner residual amount detection member 91 comes into contact.

Stirring member 84 is provided so as to oscillate in the direction crossing the direction in which the liquid surface of toner is displaced. Specifically, stirring member 84 is provided so as to oscillate in the direction orthogonal to the direction in which the liquid surface of toner is displaced.

Toner residual amount detection unit 90 is provided so as to detect a residual amount of the toner stored in the toner storage unit. Toner residual amount detection unit 90 includes toner residual amount detection member 91, an eccentric cam 92, a movable piece 94, and a photoelectric sensor 95.

Toner residual amount detection member 91 has a pair of arm portions 911 and a detection plate 912 connecting the leading end sides of the pair of arm portions 911. The pair of arm portions 911 are rotatably fixed to pins 93 provided in the pair of lateral surfaces 721 of toner storage unit 72. This allows toner residual amount detection member 91 to move between a retracted position at which toner residual amount detection member 91 is retracted from the liquid surface of toner and a contact position at which toner residual amount detection member 91 comes into contact with the liquid surface of toner. Toner residual amount detection member 91 rotates between the retracted position and the contact position.

Eccentric cam 92 is fixed to rotational shaft 81 and rotates about axis of rotation CL1 while being eccentric. Eccentric cam 92 rotates in synchronization with axis of rotation CL1. Arm portion 911 is provided to abut against eccentric cam 92. Arm portion 911 accordingly follows the rotation of eccentric cam 92, so that toner residual amount detection member 91 rotates about pin 93.

Movable piece 94 rotates in conjunction with the rotation of arm portion 911. Movable piece 94 rotates so as to come in between a light-emitting portion and a light-receiving portion which are included in photoelectric sensor 95. Photoelectric sensor 95 detects a toner residual amount based on fluctuations in the amount of detection light, which is emitted from the light-emitting portion toward the light-receiving portion, due to the operation of movable piece 94.

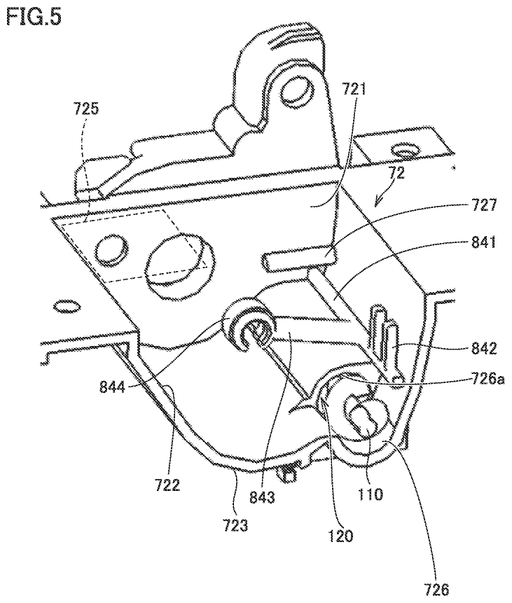

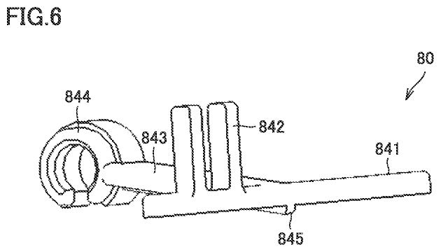

FIG. 4 partially shows a stirring unit of the toner supply device according to the embodiment. FIG. 5 is a perspective view of a stirring member according to the embodiment. FIG. 6 is a perspective view showing configurations of the stirring member and its vicinity according to the embodiment. A detailed configuration of stirring unit 80 will be described with reference to FIGS. 4 to 6.

As shown in FIG. 4, rotational shaft 81 includes a first portion 811 and a second portion 812. First portion 811 and second portion 812 are arranged side by side in the direction of axis of rotation CL1. First portion 811 is provided with an attachment portion 81a for attaching stirring paddle 82. In a planar surface portion of attachment portion 81a, projections 81b projecting to be orthogonal to the planar surface are provided. Stirring paddle 82 engages with projections 81b, so that stirring paddle 82 is fixed to first portion 811.

Screw portion 83 and eccentric cam 92 are provided to second portion 812. Screw portion 83 has an elliptical shape as viewed from the direction of the axis of rotation of screw portion 83. Screw portion 83 is spirally provided. A spiral start position P1 of screw portion 83 and a spiral end position P2 of screw portion 83 are located on a major shaft 83a as viewed from the direction of the axis of rotation of screw portion 83. Such a positional relationship can increase the force by which toner is transported by screw portion 83. A spiral winding number is approximately one turn. Spiral start position P1 and spiral end position P2 overlap each other as viewed from the direction of the axis of rotation of screw portion 83.

As viewed from the direction of the axis of rotation of screw portion 83, major shaft 83a has a first portion 83a1, which projects from the axis of rotation of screw portion 83, and a second portion 83a2, which projects from the axis of rotation of screw portion 83 opposite to first portion 83a1 to be shorter than first portion 83a1.

Shaft 87 is connected between first portion 811 and second portion 812 of rotational shaft 81 to be rotatable about axis of rotation CL1. Shaft 87 revolves about axis of rotation CL1. The direction of an axis CL2 of shaft 87 is parallel to the direction of axis of rotation CL1 of rotational shaft 81. Stirring member 84 fits shaft 87.

As shown in FIGS. 4 to 6, stirring member 84 includes an extension 841, a protrusion 842, an attachment portion 843, and a projecting portion 845.

Extension 841 extends in the direction of axis of rotation CL1 of rotational shaft 81, that is, in the direction of the axis of rotation of stirring paddle 82. Extension 841 extends in the direction orthogonal to the direction in which the liquid surface of toner is displaced (in the up-down direction) and the direction in which stirring member 84 oscillates. Extension 841 has a rod shape.

Protrusion 842 protrudes from extension 841 toward the liquid surface of toner. Protrusion 842 protrudes upward from extension 841. Protrusion 842 is provided on a first end side of extension 841. Protrusion 842 is provided on the side close to toner intake portion 726 with respect to inlet 725 (FIG. 3). Protrusion 842 is located above transport member 110 exposed to the inside of toner storage unit 72.

Projecting portion 845 protrudes from extension 841 toward bottom portion 723 of toner storage unit 72. Projecting portion 845 protrudes downward from extension 841. Projecting portion 845 is provided slidably on bottom portion 723 of toner storage unit 72. The friction between stirring member 84 and bottom portion 723 can be reduced by providing projecting portion 845 as described above, allowing stirring member 84 to oscillate stably. Also, projecting portion 845 forms a clearance capable of preventing aggregation of toner between extension 841 and bottom portion 723.

Attachment portion 843 is provided at the center of extension 841. Attachment portion 843 is provided to extend toward shaft 87. A hook 844 which hooks onto shaft 87 is provided at the tip of attachment portion 843. Hook 844 has a cylindrical shape with a circumferential missing part. Hook 844 loosely fits shaft 87. Hook 844 fits shaft 87 with a clearance therebetween so as to prevent aggregation of toner between hook 844 and shaft 87.

Hook 844 fits shaft 87 to be movable about central axis CL2 of shaft 87. Consequently, even when shaft 87 rotates about axis of rotation CL1, hook 844 rotates relative to shaft 87 so as to prevent or reduce the upward movement of extension 841.

A movement regulation portion 727 is provided on the inner circumferential surface of toner storage unit 72, more specifically, lateral surface 721. Movement regulation portion 727 regulates the upward movement of extension 841. Movement regulation portion 727 protrudes from lateral surface 721 in its normal direction. Movement regulation portion 727 extends in the direction of oscillation of extension 841.

Shaft 87 rotates about axis of rotation CL1 with movement regulation portion 727 regulating upward movement of extension 841, thus allowing extension 841 to oscillate in the direction crossing axis of rotation CL1. Specifically, extension 841 can be oscillated in the direction orthogonal to the direction (up-down direction) in which the liquid surface of toner is displaced and the direction of axis of rotation CL1. Consequently, extension 841 oscillates in conjunction with the rotation of rotational shaft 81, that is, the rotation of stirring paddle 82.

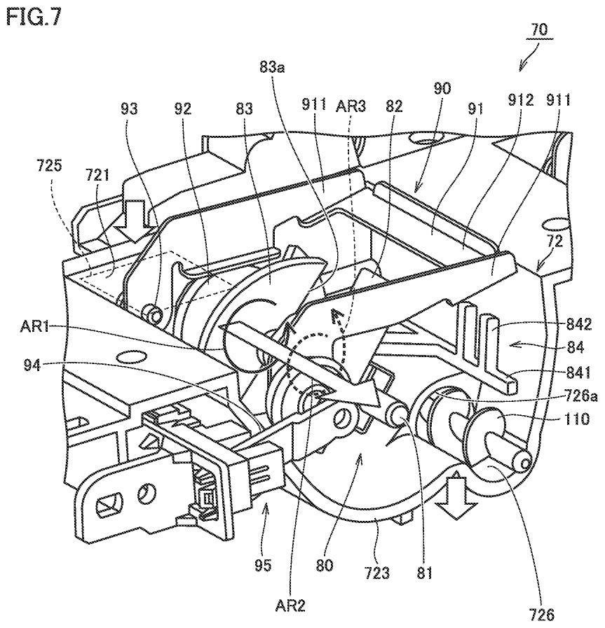

FIG. 7 is a sectional perspective view showing how a screw portion and a stirring paddle stir toner in the toner supply device according to the embodiment. How screw portion 83 and stirring paddle 82 stir toner will be described with reference to FIG. 7.

As shown in FIG. 7, the rotation of rotational shaft 81 about axis of rotation CL1 (see FIG. 4) causes screw portion 83 and stirring paddle 82 to rotate about axis of rotation CL1. The rotation of screw portion 83 as indicated by an arrow AR1 causes the toner stored in toner storage unit 72 to be transported toward stirring paddle 82 in the direction of axis of rotation CL1 as indicated by an arrow AR2. Stirring paddle 82 rotates as indicated by an arrow AR3 to stir the toner transported by screw portion 83, thereby moving part of the transported toner to toner intake portion 726.

The toner transported along axis of rotation CL1 is stirred by stirring paddle 82 as described above, so that the toner remained at a position apart from toner intake portion 726 in the direction of axis of rotation CL1 can be stirred while being transported by screw portion 83. This prevents or reduces curing of the toner at the position apart from toner intake portion 726 in the direction of axis of rotation CL1, thus allowing the toner to flow stably.

Screw portion 83 is disposed on the side close to inlet 725 with respect to stirring paddle 82, and stirring paddle 82 is disposed on the side close to toner intake portion 726 with respect to screw portion 83, so that the toner remained on the inlet 725 side can be transported toward stirring paddle 82 by screw portion 83. This can prevent or reduce curing of the toner on the inlet 725 side.

Further, stirring paddle 82 having a plate shape is provided to be parallel to major shaft 83a of screw portion 83 as viewed from the direction of the axis of rotation of screw portion 83 (the direction of axis of rotation CL1 of rotational shaft 81), and the rotational phase of stirring paddle 82 and the rotational phase of screw portion 83 are substantially identical to each other.

As described above, spiral start position P1 and spiral end position P2 of screw portion 83 are located on major shaft 83a of screw portion 83 as viewed from the direction of the axis of rotation of screw portion 83. This increases the force of transportation by screw portion 83, and the toner transported for a long distance can be stirred by stirring paddle 82. The toner in toner storage unit 72 can thus be stirred efficiently.

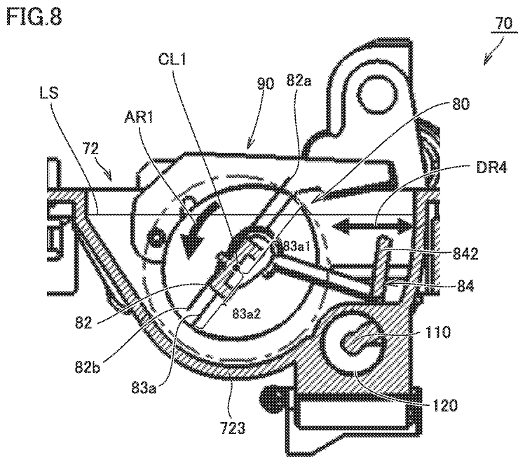

FIG. 8 is a sectional view showing how the stirring member stirs toner in the toner supply device according to the embodiment. How stirring member 84 stirs toner will be described with reference to FIG. 8.

As shown in FIG. 8, stirring member 84 oscillates in the direction crossing (more particularly, orthogonal to) axis of rotation CL1 upon rotation of rotational shaft 81, as indicated by an arrow DR4.

As described above, extension 841 of stirring member 84 is disposed above transport member 110. The oscillation of stirring member 84 can stir a portion of the toner stored in toner storage unit 72, which is located above transport member 110. This can prevent or reduce remaining and curing of the toner located above transport member 110.

Stirring member 84 oscillates to move away from screw portion 83 when first portion 83a1 on major shaft 83a of screw portion 83 rotates to be closer to stirring member 84 (more particularly, extension 841) and approach screw portion 83 when first portion 83a1 rotates to be farther from stirring member 84 (more particularly, extension 841). This can prevent stirring member 84 from interfering with screw portion 83.

Also, stirring paddle 82 has the shape of a plate disposed parallel to axis of rotation CL1 as described above, and has a first end 82a apart from the axis of rotation (axis of rotation CL1) of stirring paddle 82 and a second end 82b close to the axis of rotation of stirring paddle 82 as viewed from the direction of axis of rotation CL1.

Stirring member 84 oscillates to move away from stirring paddle 82 when first end 82a of stirring paddle 82 rotates to be closer to stirring member 84 (more particularly, extension 841) and approach stirring paddle 82 when second end 82b of stirring paddle 82 rotates to be farther from stirring member 84 (more particularly, extension 841). This can prevent stirring member 84 from interfering with stirring paddle 82.

Extension 841 is disposed below a liquid surface LS of toner with which toner residual amount detection member 91 comes into contact. This allows stirring member 84 to stir the toner located below liquid surface LS of toner with which toner residual amount detection member 91 comes into contact. This can prevent or reduce remaining and curing of the toner located below liquid surface LS of toner with which toner residual amount detection member 91 comes into contact. Consequently, the toner can flow stably.

Stirring member 84 stirs the toner with detection plate 912 of toner residual amount detection member 91 being apart from liquid surface LS of toner. This can prevent or reduce the oscillation of liquid surface LS of toner by stirring member 84 when detection plate 912 is in contact with liquid surface LS of toner. Consequently, a toner residual amount can be detected accurately.

As described above, in toner supply device 70 according to the embodiment, the toner transported along axis of rotation CL1 by screw portion 83 is stirred by stirring paddle 82, so that the toner remaining at a position apart from toner intake portion 726 in the direction of axis of rotation CL1 can be stirred while being transported by screw portion 83. This can prevent or reduce curing of the toner at the position apart from toner intake portion 726 in the direction of axis of rotation CL1, allowing the toner to flow stably.

Although the above embodiment has described the case in which stirring paddle 82 and screw portion 83 are fixed to rotational shaft 81 as an example, otherwise, they may be fixed to separate shafts. In this case, the axis of rotation of stirring paddle 82 and the axis of rotation of screw portion 83 are preferably parallel to each other.

Although the above embodiment has described the case in which stirring member 84 performs stirring by oscillation of extension 841 extending along axis of rotation CL1 as an example, the present invention is not limited thereto. Stirring member 84 can change its shape as appropriate as long as it can operate in conjunction with the rotation of stirring paddle 82.

The toner supply device according to the present disclosure described above comprises a toner storage unit that stores toner for supply, and a stirring unit that stirs the toner stored in the toner storage unit. The toner storage unit includes an inlet for introducing the toner from a toner container to the toner storage unit, and an intake portion that takes in the toner to a supply path for supplying the toner toward a developing device. The stirring unit includes a paddle portion provided to be rotatable about an axis of rotation for moving the toner toward the intake portion, and a screw portion for transporting the toner toward the paddle portion. The screw portion transports the toner in a direction of the axis of rotation of the paddle portion.

In the toner supply device according to the present disclosure, the stirring unit may include a rotational shaft for rotating the paddle portion. In this case, the screw portion may be provided to the rotational shaft provided with the paddle portion.

In the toner supply device according to the present disclosure, the screw portion is preferably disposed on a side close to the inlet with respect to the paddle portion, and the paddle portion is preferably disposed on a side close to the intake portion with respect to the screw portion.

In the toner supply device according to the present disclosure, the screw portion may have an elliptical shape as viewed from the direction of an axis of rotation of the screw portion.

In the toner supply device according to the present disclosure, the stirring unit may further include a stirring member that oscillates in a direction crossing the direction of the axis of rotation of the screw portion. In this case, a major shaft of the elliptical shape may cross the axis of rotation of the screw portion such that a center of the major shaft is spaced from the axis of rotation of the screw portion. The major shaft may include a first portion protruding from the axis of rotation of the screw portion, and a second portion protruding from the axis of rotation of the screw portion in a direction opposite to the first portion to be shorter than the first portion. In this case, the stirring member preferably oscillates to move away from the screw portion when the first portion rotates to be closer to the stirring member and approach the screw portion when the first portion rotates to be farther from the stirring member.

In the toner supply device according to the present disclosure, the screw portion may be spirally provided. In this case, a spiral start position and a spiral end position of the screw portion may be located on the major shaft of the elliptical shape as viewed from the direction of the axis of rotation of the screw portion.

In the toner supply device according to the present disclosure, the paddle portion may have a plate shape and may be provided to be parallel to the major shaft as viewed from the direction of the axis of rotation of the screw portion. The paddle portion may have a rotational phase substantially identical to a rotational phase of the screw portion.

A developing device according to the present disclosure develops a latent image formed on an image carrier to form a toner image on the image carrier, and is configured to be supplied with toner from the toner supply device.

An image forming apparatus according to the present disclosure comprises the developing device and a transfer unit that transfers the toner image developed by the developing device onto a recording medium.

Although embodiments of the present invention have been described and illustrated in detail, the disclosed embodiments are made for purposes of illustration and example only and not limitation. The scope of the present invention should be interpreted by terms of the appended claims.

What is claimed is:

1. A toner supply device comprising:
a toner storage unit that stores toner for supply; and
a stirring unit that stirs the toner stored in the toner storage unit, wherein
the toner storage unit includes
an inlet for introducing the toner from a toner container to the toner storage unit, and
an intake portion that takes in the toner to a supply path for supplying the toner toward a developing device,
the stirring unit includes
a paddle portion provided to be rotatable about an axis of rotation for moving the toner toward the intake portion, and
a screw portion for transporting the toner toward the paddle portion, and
the screw portion transports the toner in a direction of the axis of rotation of the paddle portion.

2. The toner supply device according to claim 1, wherein
the stirring unit includes a rotational shaft for rotating the paddle portion, and
the screw portion is provided to the rotational shaft provided with the paddle portion.

3. The toner supply device according to claim 1, wherein
the screw portion is disposed on a side close to the inlet with respect to the paddle portion, and
the paddle portion is disposed on a side close to the intake portion with respect to the screw portion.

4. The toner supply device according to claim 1, wherein the screw portion has an elliptical shape as viewed from the direction of an axis of rotation of the screw portion.

5. The toner supply device according to claim 4, wherein
the stirring unit further includes a stirring member that oscillates in a direction crossing the direction of the axis of rotation of the screw portion,
a major shaft of the elliptical shape crosses the axis of rotation of the screw portion such that a center of the major shaft is spaced from the axis of rotation of the screw portion,
the major shaft includes
a first portion protruding from the axis of rotation of the screw portion, and
a second portion protruding from the axis of rotation of the screw portion in a direction opposite to the first portion to be shorter than the first portion, and
the stirring member oscillates to
move away from the screw portion when the first portion rotates to be closer to the stirring member, and
approach the screw portion when the first portion rotates to be farther from the stirring member.

6. The toner supply device according to claim 4, wherein
the screw portion is spirally provided, and
a spiral start position and a spiral end position of the screw portion are located on the major shaft of the elliptical shape as viewed from the direction of the axis of rotation of the screw portion.

7. The toner supply device according to claim 4, wherein
the paddle portion has a plate shape and is provided to be parallel to the major shaft as viewed from the direction of the axis of rotation of the screw portion, and
the paddle portion has a rotational phase substantially identical to a rotational phase of the screw portion.

8. A developing device that develops a latent image formed on an image carrier to form a toner image on the image carrier, wherein the developing device is configured to be supplied with toner from a toner supply device according to claim 1.

9. An image forming apparatus comprising:
a developing device according to claim 8; and
a transfer unit that transfers the toner image developed by the developing device onto a recording medium.
